(19) United States
(12) Patent Application Publication
(10) Pub. No.: US 2023/0246205 A1
(43) Pub. Date: Aug. 3, 2023

(54) BIPOLAR PLATE

(71) Applicant: AUDI AG, Ingolstadt (DE)

(72) Inventors: Oliver KEITSCH, Heilbronn (DE); Sebastian VOIGT, Heilbronn (DE); Fabian LIPPL, Mannheim (DE)

(21) Appl. No.: 17/927,554

(22) PCT Filed: Apr. 26, 2021
(86) PCT No.: PCT/EP2021/060786

§ 371 Date: Nov. 23, 2022

(30) Foreign Application Priority Data
May 26, 2020 (DE) 10 2020 114 066.5

(51) Int. Cl. H01M 8/0263; H01M 8/0265

(52) U.S. Cl. CPC H01M 8/0263; H01M 8/0265

(57) ABSTRACT

A bipolar plate is provided including an outlet port and an inlet port with at least one flow field having a plurality of ducts connecting the inlet port to the outlet port, and with at least one bypass duct at a side of the at least one flow field. A flow resistance in the at least one bypass duct is determined by the design of the at least one bypass duct. A blocking element does not project into a cross section of the at least one bypass duct.

### BACKGROUND

### Technical Field

Embodiments of the present disclosure relate to a bipolar plate including an inlet port, an outlet port, at least one flow field having a plurality of ducts connecting the inlet port to the outlet port, and at least one bypass duct at a side of the at least one flow field, wherein a flow resistance in the at least one bypass duct is determined by the design of the at least one bypass duct, and wherein a blocking element does not project into a cross section of the at least one bypass duct.

### Description of the Related Art

A fuel cell comprises a membrane-electrode arrangement formed from a proton-conducting membrane, on one side of which the anode is formed and on the other side of which the cathode is formed. In a fuel cell device, several fuel cells are generally combined linearly to form a fuel cell stack in order to enable a sufficiently large power output.

Reactant gases are supplied to the electrodes of the fuel cells by means of bipolar plates, namely hydrogen in particular on the anode side and oxygen or an oxygen-containing gas, in particular air, on the cathode side. When supplying the fuel cell with the reactants, said reactants are guided to the plate via a duct, which plate is intended to effect the distribution of the reactants into an active area using the duct or a plurality of ducts, in order to cover the entire surface of the electrodes as uniformly as possible by means of a flow field. Due to the chemical reaction taking place over the entire surface of the active region, the fresh reactant gases are progressively consumed such that the partial pressures of the reactant gases decrease from inlet to outlet while the proportion of product gases increases.

In addition to the reactant gases, a cooling medium is also passed through the bipolar plate, so that three different media have to be guided in a technically tightly separated manner in the smallest of spaces. Therefore, as a rule, two metallic formed parts are welded to form a bipolar plate, wherein an overlapping area around the active flux field must be maintained due to the space requirement, in which cavities arise due to the manufacturing and assembly tolerances, through which reactant gases can flow past the flow field what should be reduced by blocking elements for BIPOLAR PLATE the leakage flow. However, since the cooling medium also flows through the bipolar plate, a compromise must be made between avoiding the leakage flow for the reaction gases and the cooling medium when using the blocking elements.

In DE 10 2017 118 143 A1, an embossing is formed as a blocking element in a bypass duct of a first bipolar plate, which disrupts the direction of the reactant flow and causes turbulence and increases in pressure, which deflect the reactant from the bypass duct into a gas diffusion layer which is arranged between the first bipolar plate and a second bipolar plate. WO 2003/041199 A2 describes a bipolar plate made of an electrically conductive plate, on one side of which a first flow field and on the other side a second flow field are formed, in such a way that the shape of the first flow field and the second flow field is chosen such that these are not directly on top of each other. The ducts of the flow fields are meander-shaped to increase the duct length. US 2018/0342744 A1 discloses the structure of a fuel cell stack in which fuel cells are combined in several layers and arranged between end plates. An intermediate plate is arranged between each end plate and the adjacent fuel cell of the fuel cell stack, in which distribution structures are formed for introducing and discharging the reaction gases. A bypass passage is formed in the intermediate plate and meanders from the inlet port to the outlet port to collect condensed water.

### BRIEF SUMMARY

Some embodiments relate to a bipolar plate in which the flow can be set in a simplified manner by way of a reaction gas bypass.

The bipolar plate mentioned at the outset offers the advantage that, on the one hand, a better uniform distribution is achieved by allowing a mass flow in the side area of the at least one flow field in a targeted manner and, on the other hand, there is a reduction in cavities through which the coolant could flow. This results in a reduction in the thermal mass of the coolant, i.e., a reduced absolute heat capacity of the coolant in the fuel cell stack, as a result of which frost starting properties are improved. Space advantages can also be achieved by not including blocking elements. Finally, it is possible to optimize the undesired leakage flows from the reaction gases and the coolant. The at least one bypass duct itself runs in an area of the plate which lies outside the active area in which the electrochemical reaction takes place.

These advantages are particularly pronounced if there is an appropriately designed bypass duct on each of opposing sides of each of the flow fields.

In this case if a length of the at least one bypass duct is increased by repeated changes in direction between the inlet port and the outlet port, since a parameter for setting the flow resistance is available in a simple and easy-to-manufacture manner by increasing the contact surface of the flow through the at least one bypass duct with a duct wall.

Again in the interests of simplified manufacture and maximizing the length of the at least one bypass duct, the changes in direction may be regularly distributed between the inlet port and the outlet port and are shaped according to a shape that has a sawtooth profile, a rectangular profile, a double serpentine profile, or a tongue profile. The profiles have in common that changes in direction of the flow are forced in the at least bypass duct, each change in direction increasing the flow resistance, in particular if the change in direction includes large angles between the branches of the at least one bypass duct. In particular, the double serpentine profile with the basic shape of a capital omega provides many sharp changes in direction in a small space with a large increase in the length of the bypass duct.

In addition to the length of the at least one bypass duct, another parameter for increasing the flow resistance is available, so that the cross section of the at least one bypass duct is shaped according to a cross-sectional shape having a V-profile, a rectangular profile, a semicircular profile, a trapezoidal profile, or a hammerhead profile. In particular, these profiles do not provide the maximum for the duct content in relation to its wall area, so that the flow resistance increases again due to the increased wall area for a given flow volume.

For manufacturing reasons in particular, the sides of the profiles can be rounded.

The fact that a surface in the at least one bypass duct may be roughened also serves to increase the flow resistance, and this can be achieved by a suitable surface treatment or by a coating.

If the at least one bypass duct has at least one branch between the inlet port and the outlet port, then the flow resistance is also increased, namely due to an increase in the wall area in relation to the flow volume. The bifurcation can be in the form of two, three or more branches and also repeat themselves.

Forming a beginning of the at least one bypass duct by a branch from a side duct of the at least one flow field improves control of flow through the at least one bypass duct.

Alternatively, there is also the possibility that the beginning of the at least one bypass duct is formed in a distribution area of the inlet port, upstream of the flow field. This option serves in particular to increase the length of the at least one bypass duct and to pass the leakage flow before it reaches areas where it is undesirable or disadvantageous.

The features and combinations of features mentioned above in the description and the features and combinations of features mentioned below in the description of the figures and/or shown alone in the figures can be used not only in the combinations specified, but also in other combinations or on their own, without limiting the scope the disclosure. The disclosure therefore also encompasses and discloses embodiments that are not explicitly shown or explained in the figures, but that emerge from the explained embodiments and can be generated through separate combinations of features.

### BRIEF DESCRIPTION OF THE SEVERAL VIEWS OF THE DRAWINGS

Further advantages, features and details of the disclosure result from the claims, the following description of embodiments and based on the drawings.

FIG. 1 shows a schematic illustration of a fuel cell device with a fuel cell stack having a plurality of fuel cells, the fuel cells of which have bipolar plates.

FIG. 2 shows a plan view of a schematic illustration of a bipolar plate known from the prior art.

FIG. 3 shows a plan view of a schematic illustration of a bipolar plate known from the prior art with the schematically represented drop in concentration of the reactant gas in a flow field and indicated bypass flows.

FIG. 4 shows a cross section through a bipolar plate known from the prior art in the duct direction of the flow field.

FIG. 5 shows an illustration of a bipolar plate corresponding to FIG. 4 with a reaction gas bypass and a coolant bypass.

FIG. 6 shows a schematic diagram for the diversion of the reaction gas bypass from a side duct of the flow field.

FIG. 7 shows a schematic diagram for the diversion of the reaction gas bypass from a distribution area.

FIG. 8 shows a schematic diagram for the beginning of the reaction gas bypass adjacent to a medium port for the reaction gas.

FIG. 9 shows a schematic illustration of a course of the reaction gas bypass next to the flow field.

FIG. 10 shows a schematic illustration of another course of the reaction gas bypass next to the flow field.

FIG. 11 shows a schematic illustration of yet another course of the reaction gas bypass next to the flow field.

FIG. 12 shows a schematic illustration of still another course of the reaction gas bypass next to the flow field.

FIG. 13 shows a schematic illustration of the course of the reaction gas bypass next to the flow field.

FIG. 14 shows an illustration corresponding to FIG. 9 including variants with regard to a bifurcation of the reaction gas bypass.

FIG. 15 shows an illustration of the variants with regard to the cross-sectional profile of the reaction gas bypass.

### DETAILED DESCRIPTION

FIG. 1 shows a schematic illustration of a fuel cell device 1 which has a fuel cell or a plurality of fuel cells combined to form a fuel cell stack 2.

The fuel cell stack 2 consists of a plurality of fuel cells connected in series. Each of the fuel cells comprises an anode and a cathode, and a proton conductive membrane separating the anode from the cathode. The membrane is formed from an ionomer, such as a sulfonated tetrafluoroethylene polymer (PTFE) or a polymer of perfluorinated sulfonic acid (PFSA). Alternatively, the membrane can be formed as a sulfonated hydrocarbon membrane.

Additionally, a catalyst can be blended with the anodes and/or the cathodes, and the membranes may be coated with a catalyst layer made of a noble metal or mixtures comprising noble metals such as platinum, palladium, ruthenium or the like on their first side and/or on their second side, which serve as a reaction accelerator in the reaction of the respective fuel cell.

Fuel (for example hydrogen) is supplied to the anodes via anode chambers within the fuel cell stack 2. In a polymer electrolyte membrane fuel cell (PEM fuel cell) fuel or fuel molecules are split into protons and electrons at the anode. The membrane lets the protons (for example, H⁺) through, but is impermeable to the electrons (e⁻). The following reaction takes place at the anode: 2H₂ ➜ 4H⁺ + 4e⁻ (oxidation/donation of electrons). While the protons pass through the membrane to the cathode, the electrons are conducted via an external circuit to the cathode or to an energy store. Via cathode chambers within the fuel cell stack 2, cathode gas (for example oxygen or oxygen-containing air) can be supplied to the cathodes, so that the following reaction takes place on the cathode side: O₂ + 4H⁺ + 4e⁻ ➜ 2H₂O (reduction/electron acceptance).

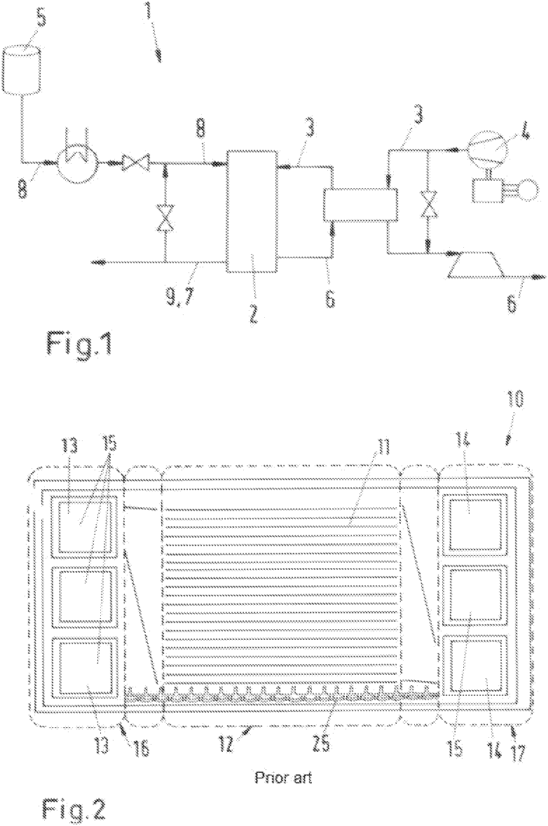

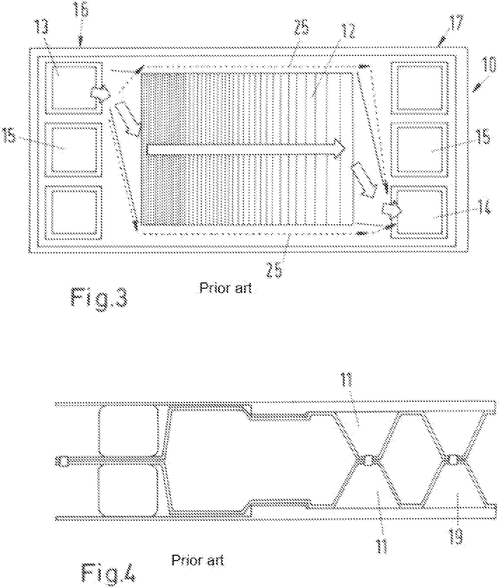

Via a cathode fresh gas line 3, compressed air is supplied to the fuel cell stack 2 by a compressor 4. In addition, the fuel cell is connected to a cathode exhaust gas line 6. On the anode side, hydrogen stored in a hydrogen tank 5 is supplied to the fuel cell stack 2 in order to provide the reactants required for the electrochemical reaction in a fuel cell. These gases are transferred to bipolar plates 10 in which ducts 11 are formed and combined to form a flow field 12 for distribution of the gases to the membrane. In addition, the bipolar plates 10 are provided for the passage of a coolant duct 19, so that three different media can be routed in a very small space. Bipolar plates 10 known from the prior art are shown in FIGS. 2 to 4, with FIG. 2 showing the inflow of a medium though an inlet port 13 with the transfer to the flow field 12, and the outflow through a first outlet port 14. The rear side of the bipolar plate 10 is available to the second reactants in a comparable manner. The inlet ports 13 can be combined in an inlet header 16 together with a medium port 15 for the coolant. Similarly, an outlet header 17 is available.

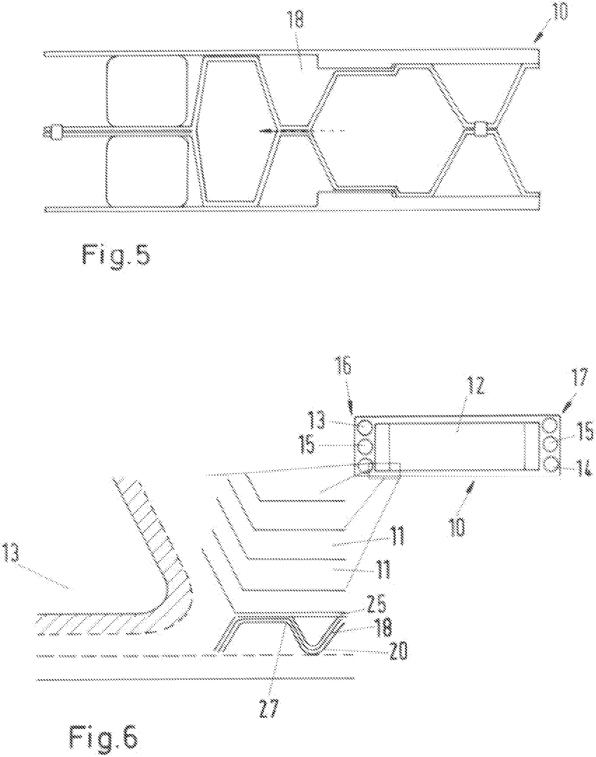

A bypass flow flows past the flow field 12, which bypass flow cannot be completely prevented even by bypass-blocking structures, the production of which represents additional effort. To avoid such bypass blocking structures 5, the bipolar plate 10 shown in FIG. 5 is configured in such a way that at least one bypass duct 18 is present at the side of at least one of the flow fields 12, with the flow resistance in the bypass duct 18 being determined by the design of the bypass duct 18 while dispensing with a blocking element projecting into the cross section of the bypass duct 18. In some embodiments, there is a correspondingly designed bypass duct 18 on both sides of both flow fields 12.

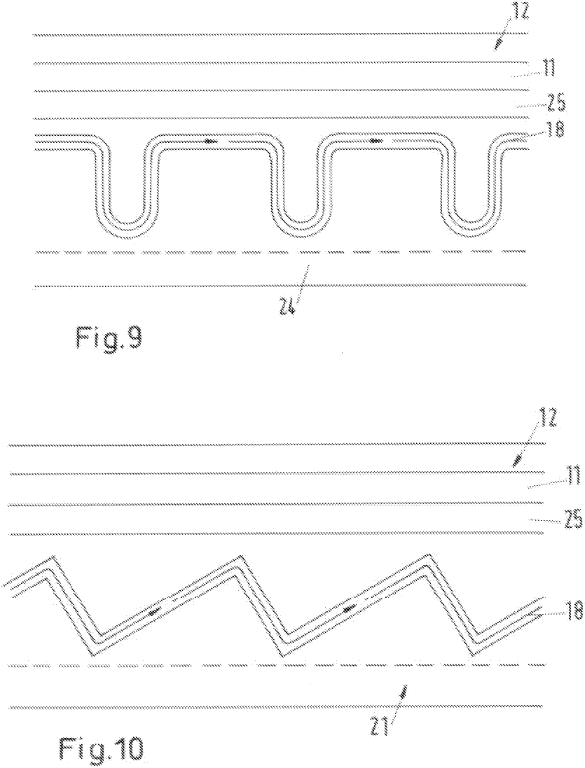

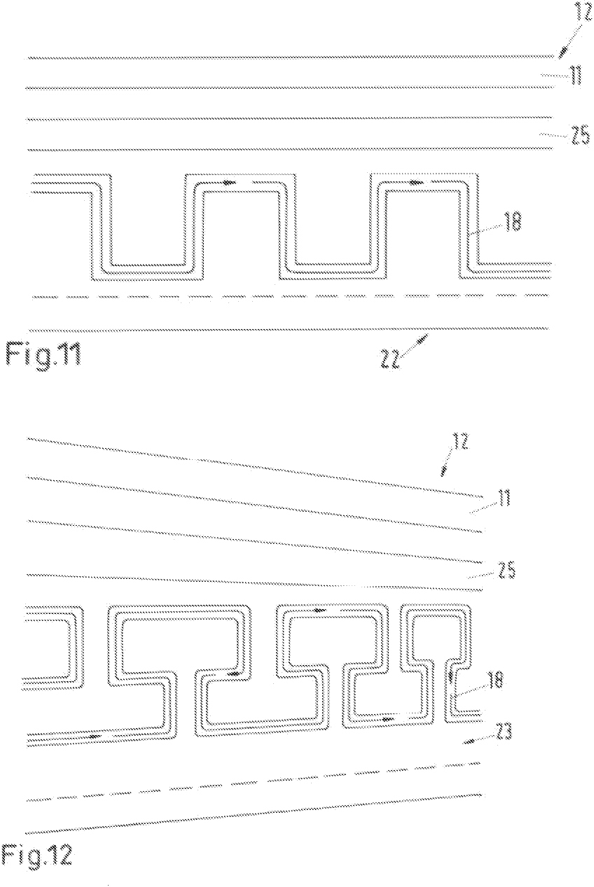

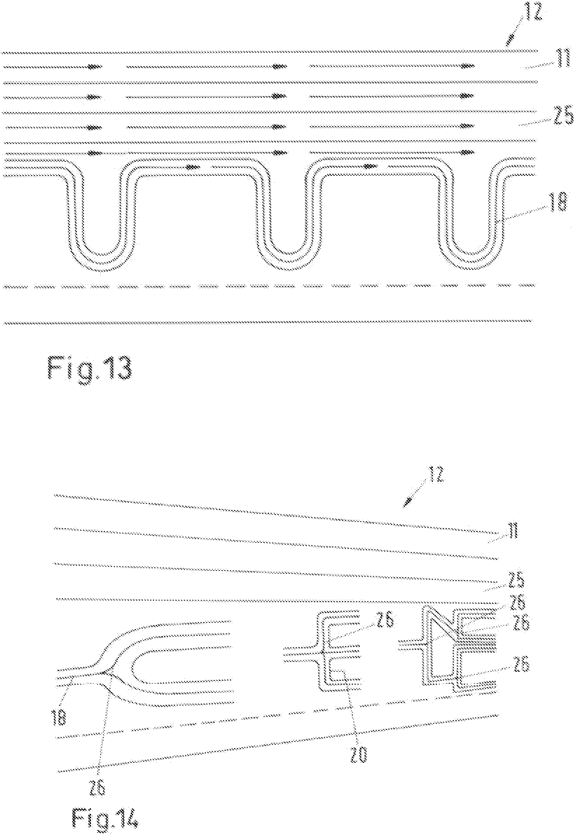

In this case, the length of the bypass duct 18 is increased by repeated changes in direction 20 between the inlet port 13 and the outlet port 14, the changes in direction 20 taking place in a regularly distributed manner between the inlet port 13 and the outlet port 14. Different changes in direction 20 of the bypass duct 18 are shown in FIGS. 9 to 13, and are shaped according to a shape that is selected from a group comprising a sawtooth profile 21, a rectangular profile 22, a double serpentine profile 23, a tongue profile 24. The angle of the change in direction 20 can also vary, so that the sawtooth profile 21 can be present, for example, symmetrically as a zigzag line. The tongue profile from FIG. 9 also improves the frost start properties of a fuel cell stack 2, since the volume for a coolant flow between a side duct 25 of the flow field 12 and the bypass duct 18 is reduced and so the thermal mass of the coolant in the fuel cell stack 2 is low.

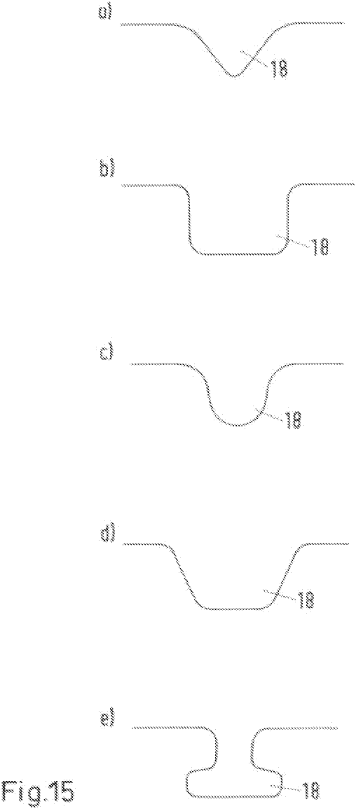

In the alternatives of FIG. 15 (from top to bottom), the cross-section of the bypass duct 18 is shaped according to a cross-sectional shape with a V-profile, a rectangular profile, a semicircular profile, a trapezoidal profile, a hammerhead profile, with the sides of the profiles being rounded with radii for a simplified manufacturing by forming processes.

There is a possibility that the surface in the bypass duct 18 is roughened.

FIG. 14 shows alternatives in which the bypass duct 18 has branches 26 between the inlet port 13 and the outlet port 14, namely bifurcation 26 into two branches (left), into three branches (middle) or a repeated bifurcation 26 into two branches (right).

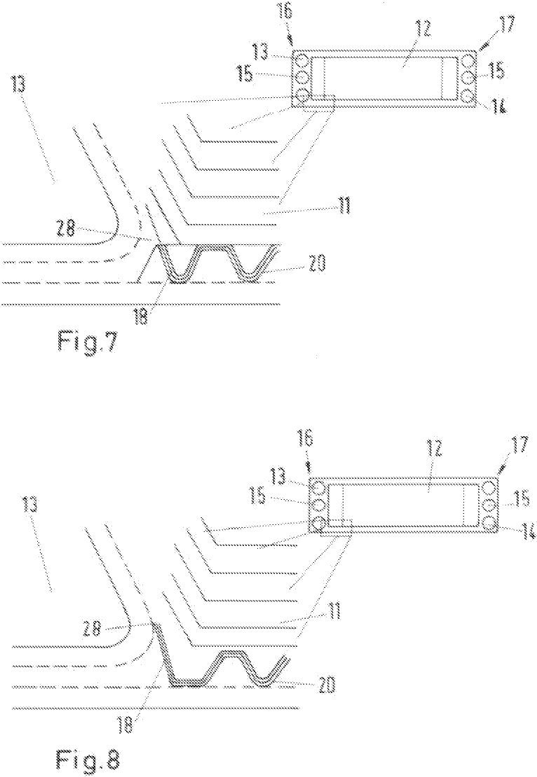

FIG. 6 shows a variant in which the beginning of the bypass duct is formed by a branch 27 from a side duct 25 of the flow field 12, while FIGS. 7 and 8 indicate that the beginning of the bypass duct 18 is formed in a distribution area 28 of the inlet port 13 upstream of the flow field 12 with different approaches to the inlet port 13.

In general, in the following claims, the terms used should not be construed to limit the claims to the specific embodiments disclosed in the specification and the claims, but should be construed to include all possible embodiments along with the full scope of equivalents to which such claims are entitled.

1. A bipolar plate comprising:
an inlet port;
an outlet port;
at least one flow field having a plurality of ducts connecting the inlet port to the outlet port; and
at least one bypass duct at a side of the at least one flow field, wherein a flow resistance in the at least one bypass duct is determined by a design of the at least one bypass duct, and wherein a blocking element does not project into a cross section of the at least one bypass duct.

2. The bipolar plate according to claim 1, wherein the at least one flow field includes a plurality of flow fields, wherein the at least one bypass duct includes a plurality of bypass ducts, and wherein a respective bypass duct is provided on each of opposing sides of each of the flow fields.

3. The bipolar plate according to claim 1, wherein the at least one bypass duct repeatedly changes in direction between the inlet port and the outlet port.

4. The bipolar plate according to claim 3, wherein the changes in direction take place in a regularly distributed manner between the inlet port and the outlet port, and wherein a shape of the at least one bypass duct has a sawtooth profile, a rectangular profile, a double serpentine profile, or a tongue profile.

5. The bipolar plate according to claim 1, wherein a shape of a profile of the cross section of the at least one bypass duct is a V-profile, a rectangular profile, a semicircular profile, a trapezoidal profile, or a hammer head profile.

6. The bipolar plate according to claim 5, wherein sides of the profile of the cross section of the at least one bypass duct are rounded.

7. The bipolar plate according claim 1, wherein a surface in the at least one bypass duct is roughened.

8. The bipolar plate according to claim 1, wherein the at least one bypass duct between the inlet port and the outlet port has at least one branch.

9. The bipolar plate according to claim 1, wherein a beginning of the at least one bypass duct is formed by a branch from a side duct of the at least one flow field.

10. The bipolar plate (10) according to claim 1, wherein a beginning of the at least one bypass duct is formed in a distribution area of the inlet port, upstream of the at least one flow field.
